(19) United States
(12) Patent Application Publication
(10) Pub. No.: US 2004/0196841 A1
(43) Pub. Date: Oct. 7, 2004

(54) Assisted port monitoring with distributed filtering

(76) Inventors: Alexander L. Tudor, Mountain View, CA (US); Allan Liu, Oakland, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/407,719

(22) Filed: Apr. 4, 2003

(51) Int. Cl. H04L 12/28

(52) U.S. Cl. 370/389; 370/351

(57) ABSTRACT

Port mirroring with filtering of information on a digital network. By replacing standard interface modules on router or switch ports with modules containing filtering hardware and a wireless link to an aggregation module, traffic of interest may be monitored. The combination of filtering on each monitored port, and communicating wirelessly with the aggregation node reduces the volume of information which must be handled, and separates it from normal network traffic.

### BACKGROUND OF THE INVENTION

### FIELD OF THE INVENTION

The present invention pertains to the art of monitoring traffic on a digital network.

### ART BACKGROUND

Routers and switches are key components in packet-switched networks ranging from small local-area-networks, to intranets within an organization, to the Internet. As their names imply, they route and switch packets of information from sources to their destinations.

Some high-end routers and switches offer the ability to mirror the traffic on any port of the device to a dedicated mirroring port. Here, mirroring refers to the process of making a one-to-one copy of the packets on a port and sending the resulting packets to the dedicated mirroring port. This allows the administrator to monitor the traffic on selected ports, and use the information, such as control information, for monitoring, administrative, or diagnostic purposes.

A number of problems are presented by current implementations of port mirroring.

First, this functionality is only available on expensive high-end routers and switches. Next, programmable packet filtering is not always supported in the mirroring process. Consequently, all packets are mirrored. An additional problem occurs because the dedicated mirror port generally has the same effective bandwidth as the ports being mirrored. As a result, attempts to monitor more than one port simultaneously can saturate the mirror port, causing packets to be dropped. In many applications, dropped packets cannot be tolerated. A further complication is that the process of mirroring requires processing resources from the router. If the router is busy doing its primary job of routing, the mirroring process is disrupted and put on hold. It is during these busy periods that the mirroring process is most useful, but given today's systems, the mirroring process is not available during these busy periods.

### SUMMARY OF THE INVENTION

Mirroring with packet filtering is provided on a per-port basis by client modules. Client modules communicate by a wireless link with an aggregation service or module. Each client module contains an input port, an output port, and a monitoring system connected to a wireless link. The aggregation module contains a wireless link, an aggregation core, and an output port.

### BRIEF DESCRIPTION OF THE DRAWINGS

The present invention is described with respect to particular exemplary embodiments thereof and reference is made to the drawings in which:

FIG. 1 shows an interface module (PRIOR ART),

FIG. 2 shows a client module,

FIG. 3 is a block diagram of a monitor core,

FIG. 4 shows an aggregation module, and

FIG. 5 is a block diagram of an aggregation core.

### DETAILED DESCRIPTION

Concurrent monitoring of packet traffic on multiple interfaces on a switch or router in a digital network is difficult to perform. It is usually impractical for cost reasons to install packet analyzers on each interface in question. While the general idea of port mirroring can be used to monitor multiple ports at the same time, its implementation in today's high-end routers and switches leaves much to be desired. The dedicated mirroring port can be easily saturated and the mirroring process can be disrupted during peak traffic periods.

Yet in most instances, the administrator performing the monitoring is only interested in particular aspects of the traffic, such as control traffic, messages of a certain type or protocol, messages containing certain addresses, or the like.

As transmission speeds of digital packet networks increase, the trend is to move from electrical signaling to optical communications for longer distances. A typical known scheme is Gigabit Ethernet, which defines an electrical signaling scheme as well as an optical scheme using a pair of optical fibers, one for traffic in each direction. While optical signal transmission has many benefits, the information they carry must be converted back to the electrical domain when such signals arrive at switches and routers. One approach to this used by many manufacturers is to use an interface converter module. One form of such a module is known as a GBIC, or GigaBit Interface Converter. Modules in the GBIC and SFP form factor are manufactured by companies such as Agilent Technologies, Finisar, JDS Uniphase, Infineon, Methode, and E20. Modules in the XENPAK form factor are manufactured by Agilent Technologies, JDS Uniphase, Opnext, and Mitsubishi. The X2 form factor is supported by Agilent Technoloties and JDS Uniphase. The XPAK form factor is supported by Intel and Infineon. XFP is supported by Agilent Technologies, Finisar, Intel, JDS Uniphase, E20, Ignis, and Opnext.

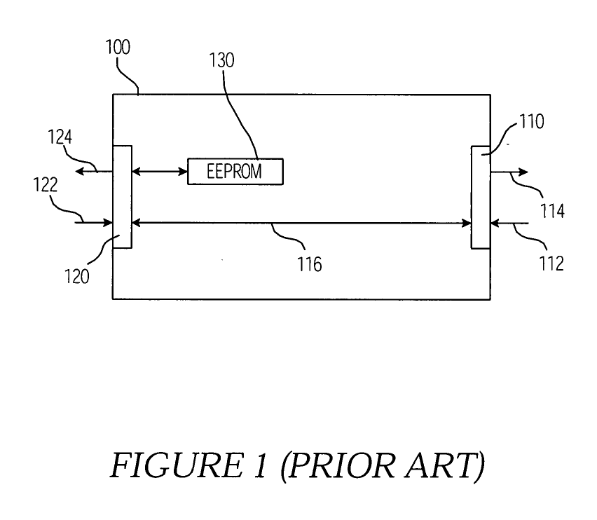

FIG. 1 shows a typical interface converter module 100 as known to the art. A first interface 110 accepts receive signal 112 and produces transmit signal 114 for a network. For an optical interface such as for short haul or long haul optical fiber, interface 110 typically includes a high-speed photodiode detector and associated shaping circuitry for converting optical receive signal 112 to electrical form, and a laser diode with control circuitry for generating optical output 114 for the electrical form. Gigabit Ethernet may also use copper wires. In such a case, interface 110 takes care of signal level conversion for transmit and receive data. Data and control signals 116 flow between interface 110 and host electrical interface 120, which has input signal 122, output signal 124, and control signals not shown. Host interface 120 connects module 100 to the switch, router, or other device. Also present in interface converter 100 is EEPROM 130, which is used to store information such as serial numbers, device characteristics, operating information, as well as manufacturer proprietary identification information.

It is common for switches and routers to rely on conversion modules to convert signals from their external form, electrical or optical, to the proper electrical levels needed for their internal use. As such, a switch or router may have a plurality of interface converter modules present, one for each port.

The present invention provides for traffic mirroring with packet filtering by providing an enhanced interface converter module which contains monitoring circuitry and a wireless data link which may communicate with a similar wireless data link in an aggregation module, or with any monitoring equipment configured with a similar wireless link and authorized to receive the information. This allows traffic to be monitored on any port or a plurality of ports using the enhanced interface converter module.

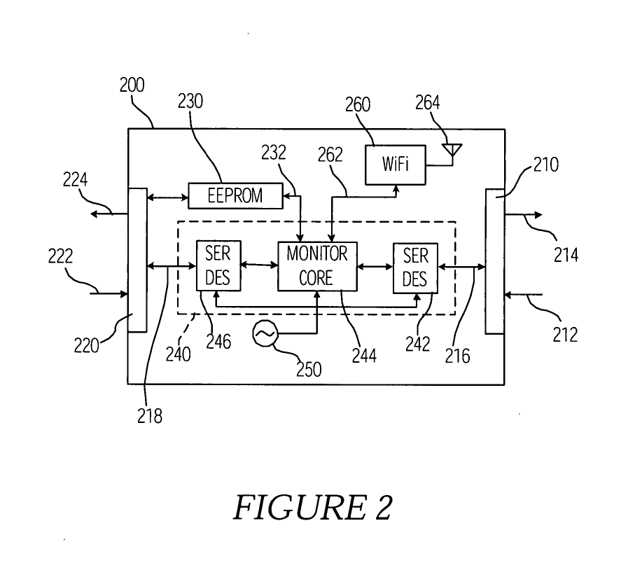

FIG. 2 shows a typical interface converter module with monitoring capabilities according to the present invention. Module 200 has input interface 210 for input signal 212 and output signal 214. For Gigabit Ethernet, interface 210 may be electrical or optical. Data 216 is passed to monitor subsystem 240 for processing. Clock 250 provides reference timing for monitor subsystem 240. Data 218 is passed to host interface 220 with input data 222, output data 224, and control lines not shown. EEPROM 230 connects to output interface 220, as well as to monitor subsystem 240, providing configuration data. For clarity, features not central to the invention such as power regulation are not shown.

In one embodiment of the invention, monitor subsystem 240 has a first serializer-deserializer 242 which passes data 216 to monitor core 244, providing functionality such as 8B/10B or 4B/5B data encoding/decoding and clock recovery. Monitor core performs the required monitoring functions, passing data to serializer-deserializer 246 which generates signals 218 for output module 220. Note that the monitor subsystem 240 does not modify the contents of the data passing between interfaces 210 and 220 nor does it impede the flow of data between the two interfaces. For the packets passing between interfaces 210 and 220 that match a set of criteria, the monitor core 244 selects them for transmission over the wireless interface 260 and antenna 264. In the preferred embodiment, wireless interface 260 is a WiFi chipset implementing one of the known 802.11 protocols such as 802.11b. Antenna 264 may be part of module 200, or provision may be made for providing an antenna external to module 200. Configuration of monitor subsystem 240 may be provided 232 through EEPROM 230, or through data transferred 262 over the WiFi link provided by wireless link 260 and antenna 264.

In the preferred embodiment, monitor subsystem 240 is implemented on a single chip. It may also be implemented as multiple chips. While the design shown in FIG. 2 takes data 216 from interface 210 and passes it through serializer-deserializer 242 and through monitor core 244 to serializer-deserializer 246, which reclocks and regenerates signals 218 for output interface 220, another approach would be to passively tap a direct electrical connection between interfaces 210 and 220, performing the monitoring function without reclocking and regenerating the data between interfaces 210 and 220.

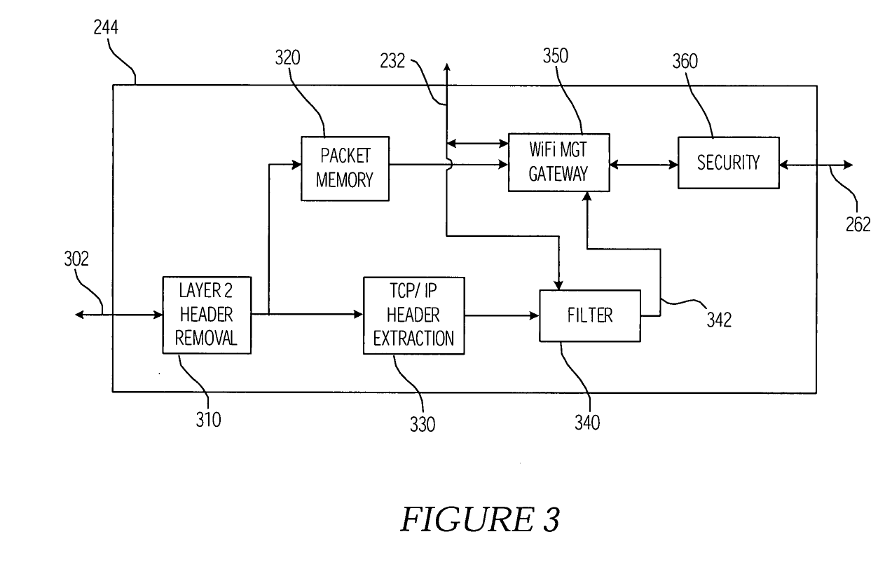

FIG. 3 shows a block diagram of a portion of monitor core 244. FIG. 3 shows the receive path, that is, the monitoring path for signals passing from input 212 of interface 210 through to output 224 of host interface 220. Similar circuitry is provided for the transmit path which monitors signals from input 222 of interface 220 passing to output 214 of interface 210. Deserialized and decoded input data 302 is stripped 310 of OSI layer 2 headers; one example of such header is the Ethernet header. The output from 310 are known OSI layer 3 packets. The resulting packet data is sent to packet memory 320 and through the layer 3 and layer 4 header extraction process 330 to filter 340; one such set of header is the IP header (layer 3) and TCP header (layer 4). Layer 3 and layer 4 header extraction 330 takes as input the OSI layer 3 packets and outputs the layer 3 and layer 4 headers to the filter engine 340. Filter engine 340 is configured 232 by data from EEPROM 230 of FIG. 2, or from data passed by WiFi management gateway 350. When filter 340 recognizes information of interest, it signals 342 gateway 350 which sends the appropriate data from packet memory 320 through security block 360 which then sends 262 the data to WiFi wireless link 260 of FIG. 2.

The security block 360 optionally performs encryption and authentication services. The information collected by the monitor core 244 can be used, for example, to construct a complete map of the network being monitored. Such information can easily be used for malicious purposes such as to construct complicated attacks against the network. To guard against the information falling into the wrong hands, encryption and authentication services are provided. Data leaving the module 200 via the wireless link will be encrypted. Data entering the module 200 via the wireless link will be authenticated. Generally, the data entering the module via the wireless link is configuration data. To guard against unauthorized changes to the configuration of the module, an authentication process will be performed on all incoming packets. Only packets from a legitimate source will be accepted. A number of public protocols are available to provide both the encryption and authentication function; one such protocol is the IP Security Protocol (IPSec).

Used in this fashion, monitoring modules are placed on ports of interest, replacing standard interface converter modules with monitoring interface converter modules as described. Since the monitoring modules communicate with the aggregation service or module using a wireless link, by definition extra wiring does not have to be provided. In an alternate embodiment, monitor modules having the same interface on both ports, such as optical or electrical, may be placed in-line, not replacing the interface converter modules of the selected device. The monitor modules of such an embodiment may require an external power source, particularly if they are placed in-line in an optical path.

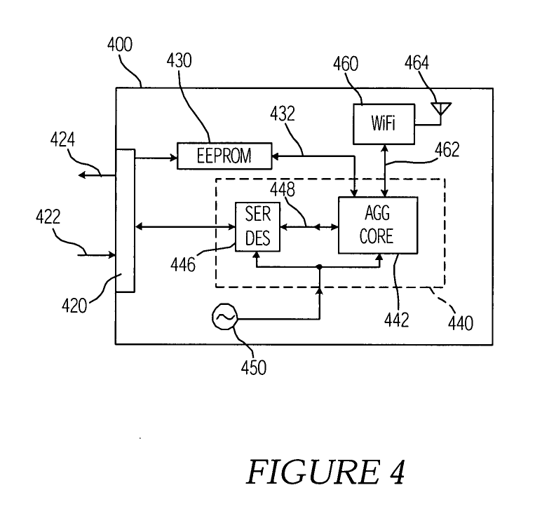

Aggregation of monitored data from one or more monitoring modules is performed by an aggregation module as shown in FIG. 4. Module 400 provides aggregated data through host interface 420, using input 422, output 424, and control lines not shown. EEPROM 430 stores identification information and may be used to store parameters. Data from one or more monitoring modules is received through antenna 464 and wireless link 460. This data is passed 462 to aggregation module 440. Aggregation core 442 gathers and formats the information, using configuration information 432 from EEPROM 430 or directly from interface 420. The resulting information is passed 448 to serializer-deserializer 446 and sent to host interface 420. Clock 450 provides a reference for aggregation core 442 and serializer-deserializer 446. While the preferred embodiment packages aggregation module 400 is the same interface converter module package used for the monitoring modules, the aggregation module need not take that form factor. Similarly, while antenna 464 is part of module 400 in the preferred embodiment, it may also be placed external to the module.

Note that the aggregation module 400 is a valid layer 2 or layer 3 endpoint. Likewise it has a valid layer 2 address, such as an Ethernet MAC address and a layer 3 address, such as an IP address. As such, it is fully accessible from the network it is attached to. This connection allows the aggregation module 400 to be remotely configured via the interface 420. To prevent unauthorized configuration of the module, all data coming in via interface 420 will be authenticated.

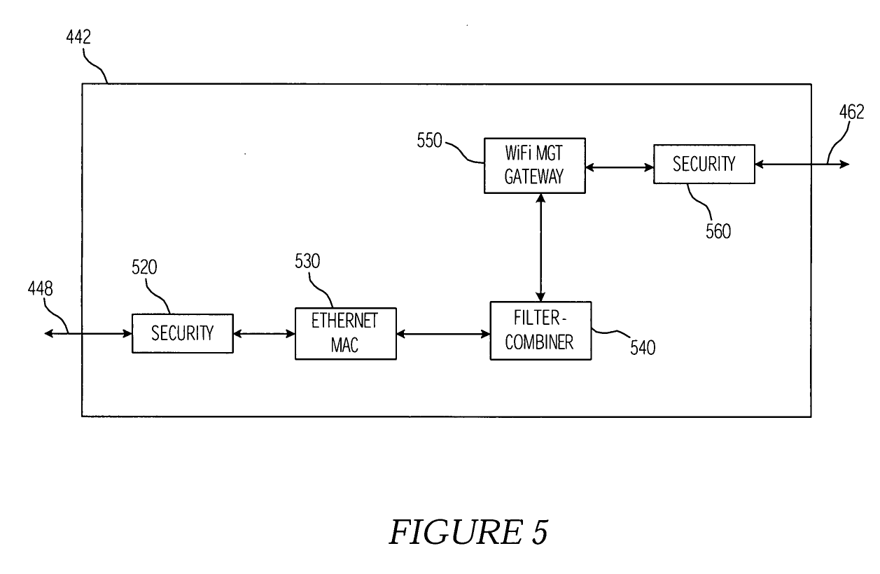

FIG. 5 shows a block diagram of aggregation core 442. Data 462 to and from the wireless link passes through security module 560. Data reduction 540 provides for further filtering and processing of data. It is important to note that the aggregator module is fully capable of reducing the amount of data that needs to be sent via interface 420. For example, the aggregator module keeps counters based on data received from the client module. The counter values need only be periodically transmitted over interface 420. A practical example of such a capability is to count the number of prefixes received from a Border Gateway Protocol (BGP) peer during a given time period. The data analysis equipment does not need to receive all protocol messages. Further data reduction can occur when the counters are programmed to transmit data over interface 420 only when pre-programmed thresholds have been reached. The processed data is passed to a layer 2 media access controller (MAC) 530, such as Ethernet layer 2 MAC 530 communicates through security block 520 and then 448 with serializer-deserializer 446 of FIG. 4 to provide standard layer 2 communications capability for the aggregation module. Security block 520 provides optional authentication and encryption services for the data communicated to the information consumer.

The aggregation process may also be undertaken by any node with a compatible wireless link which is authenticated to receive data. The aggregation process may be provided, for example by a laptop or other programmable computer equipped with a suitable wireless interface and operating software as the information consumer.

The foregoing detailed description of the present invention is provided for the purpose of illustration and is not intended to be exhaustive or to limit the invention to the precise embodiments disclosed. Accordingly the scope of the present invention is defined by the appended claims.

What is claimed is:

1. A system for aggregating information for an information consumer in a packet-switched digital network comprising:
one or more filtering nodes attached to a network device on the digital network, each filtering node having a first port connected to a network line, a second port connected to the network device, and a third port for communicating filtered information flowing between the first port and the second port to an aggregation node,
an aggregation node having a first port for communicating with one or more filtering nodes, the aggregation node aggregating the filtered information and passing the aggregated information to an information consumer on a second port.

2. The system of claim 1 where the third port of the filtering node and the first port of the aggregation mode communicate wirelessly.

3. The system of claim 1 where the first port of the filtering node is an optical port.

4. The system of claim 1 where the first port of the filtering node is an electrical port.

5. The system of claim 1 where the second port of the filtering node is an optical port.

6. The system of claim 1 where the second port of the filtering node is an electrical port.

7. The system of claim 1 where the filtering node is embedded in a module with a form factor interoperable with one or more of the GBIC, SFP, XENPAK, X2, XPAK, or XFP form factors.

8. The system of claim 1 where the option of encryption is provided in the communications between the filtering node and the aggregation node.

9 The system of claim 1 where the option of authentication is provided in the communications between the filtering node and the aggregation node.

10. The system of claim 1 where the option of encryption is provided in the communications between the aggregation node and the information consumer.

11. The system of claim 1 where the option of authentication is provided in the communications between the aggregation node and the information consumer.

12. The system of claim 1 where the aggregation mode is a stand-alone device.

13. The system of claim 1 where the aggregation node is embedded in a module with a form factor interoperable with one or more of the GBIC, SFP, XENPAK, X2, XPAK, or XFP form factors.

14. A filtering node for use on a port of a packet-switched digital networking device, the filtering node comprising:
a first port for communicating with the packet-switched digital network,
a second port for communicating with the digital networking device,
communications means for passing information between the first port and the second port,
filtering means connected to the communications means for filtering information passing between the first port and the second port and passing the filtered information to a third port.

15. The filtering node of claim 14 where the first port is an electrical port.

16. The filtering node of claim 14 where the first port is an optical port.

17. The filtering node of claim 14 where the third port is a wireless communications link.

18. The filtering node of claim 14 where the filtering node is embedded in a module with a form factor interoperable with one or more of the GBIC, SFP, XENPAK, X2, XPAK, or XFP form factors.

19. The filtering node of claim 14 where the wireless communications link provides optional authentication.

20. The filtering node of claim 14 where the wireless communications link provides optional encryption.

21. An aggregation node for use with one or more filtering nodes on a packet-switched digital network, the aggregation node comprising:
a first communications means for communicating with one or more filtering nodes,
aggregation means connected to the first communications port, and
a second communications means for providing aggregated information from the aggregation means to an information consumer.

22. The aggregation node of claim 21 where the first communications means comprises a wireless link.

23. The aggregation node of claim 22 where the first communications means includes optional authentication.

24. The aggregation node of claim 22 where the first communications means includes optional encryption.

25. The aggregation node of claim 22 where the second communications means includes optional authentication.

26. The aggregation node of claim 22 where the second communications means includes optional encryption.

27. The aggregation node of claim 21 where the aggregation node is embedded in a module with a form factor interoperable with one or more of the GBIC, SFP, XENPAK, X2, XPAK, or XFP form factors.
